(19) United States
(12) Patent Application Publication
(10) Pub. No.: US 2015/0364920 A1
(43) Pub. Date: Dec. 17, 2015

(54) SYSTEMS AND METHODS FOR IMPROVING THE ROTOR ANGLE STABILITY OF SYNCHRONOUS GENERATORS

(71) Applicant: GE Energy Power Conversion Technology Ltd., Rugby (GB)

(72) Inventors: Ryan James Konopinski, Schenectady, NY (US); John Paul Skliutas, Schenectady, NY (US); Murray Alan Eitzmann, Schenectady, NY (US); Harjeet Johal, Niskayuna, NY (US)

(21) Appl. No.: 14/301,549

(22) Filed: Jun. 11, 2014

(51) Int. Cl. H02J 3/18; H02P 9/10; H02P 9/00

(52) U.S. Cl. CPC H02J 3/18; H02P 9/006; H02P 9/102; H02J 2003/001

(57) ABSTRACT

Provided is a power plant that is connected to a transmission grid. The power plant includes a synchronous generator and a synchronous condenser connected in parallel. The power plant is configured to increase the rotor angle stability of the synchronous generator to ride through fault conditions and frequency deviations on the transmission grid.

### TECHNICAL FIELD

The technical field relates generally to systems and methods for improving the stability of synchronous generators in power plants that are exposed to fault conditions and/or frequency excursions of the power grid.

### BACKGROUND

Emerging grid codes in different parts of the world are putting onerous requirements on synchronous generators to maintain stability following a low-voltage transient condition and/or grid frequency changes. The interconnection standards often designate requirements for low-voltage ride through which are typically designated as “LVRT” requirements and requirements for rate-of-change of frequency often designated as “ROCOF” requirements.

The evolution of these mandates stemmed from the increasing penetration of renewable energy sources. In the early days of growing renewable generators, the expectation was that renewable sources would trip following a voltage disturbance on the grid. As renewable penetration increased, the tripping of these generation resources under a grid disturbance increased the severity of the contingency.

In response, utilities and regulators imposed requirements on these types of generators to stay connected to the grid during the faulted period. These same requirements are now imposed on the synchronous generators. Renewable sources often incorporate fast-acting power electronics that can be used to comply with the LVRT requirements and/or ROCOF requirements.

Unlike renewable generation, conventional synchronous generators have inherent characteristics and operating principles that have not changed significantly in decades. These characteristics and principles can limit their transient stability performance during grid faults and/or grid frequency deviations.

Some theoretical modifications that may improve the stability performance of synchronous generators require significant investment in capital expenditure and/or re-design of the synchronous generator.

### SUMMARY

The various embodiments of the present disclosure are configured to increase the rotor angle stability of synchronous generators in power plants to ride through fault conditions and frequency deviations on the transmission grid.

According to an exemplary embodiment, a power plant includes a synchronous generator and a synchronous condenser. The synchronous generator and the synchronous condenser are connected to a first low voltage terminal bus. The power plant includes a step-up transformer connected between the low voltage bus and a high voltage bus. The high voltage bus is a point of interconnection from the power plant to a power grid.

According to another exemplary embodiment, a power plant includes a synchronous generator connected to a first low voltage terminal bus; a first step up transformer connected between the first low voltage bus and a high voltage bus; a synchronous condenser connected to a second low voltage terminal bus; and a second step up transformer connected between the second low voltage bus and the high voltage bus. The high voltage terminal bus is a point of interconnection from the power plant to a power grid.

The foregoing has broadly outlined some of the aspects and features of the various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

FIG. 1 is a schematic illustration of a power plant according to an exemplary embodiment.

FIG. 2 is a schematic illustration of a power plant according to an exemplary embodiment.

FIG. 3 is a schematic illustration of a power plant according to an exemplary embodiment.

FIG. 4 is a schematic illustration of a power plant according to an exemplary embodiment.

FIG. 5 is a schematic illustration of a power plant according to an exemplary embodiment.

FIG. 6 is a schematic illustration of a power plant according to an exemplary embodiment.

FIG. 7 is a graphical illustration of machine critical clearing time (CCT) of the power plants of FIGS. 1-6 and per unit system impedance on the plant MVA base (Xs) of the grid.

FIG. 8 is a graphical illustration of machine rate of change of frequency (ROCOF) of the power plants of FIGS. 1-3 and per unit system impedance on the plant MVA base (Xs) of the grid.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

### General

This disclosure describes power plant configurations that have increased ability to tolerate longer duration faults and/or changes in grid frequency. Such power plant configurations are able to meet more stringent grid code requirements. In general, embodiments of a power plant described in further detail below include a unit that is connected to a grid at a point of interconnection. For example, the point of interconnection is a high voltage bus. The grid has a system strength represented by a per unit impedance on the plant MVA base (Xs).

The unit includes one or more synchronous generator(s) and a synchronous condenser that operate in parallel with one another and in synchronism with an AC power grid. In certain embodiments, the synchronous generator and the synchronous condenser are connected to one another on the machine (generator) side of a step-up transformer (e.g., connected to one another at a low voltage bus that is separate from the point of interconnection to the grid). In other embodiments, the synchronous generator and the synchronous condenser are connected to their own transformer while connected at the same bus in the power grid.

Synchronous generators are electrical synchronous rotating machines that are coupled mechanically, via a rotating shaft, to prime-mover(s) and are used to convert mechanical power into electrical power. Mechanical power can be derived from different fuel or power sources which could include steam turbines, gas turbines, reciprocating engines, liquid fuel, combined cycle, nuclear, hydro, and the like. The generator has a DC field and excitation system and operates in synchronism with the AC power grid.

Synchronous condensers are electrical synchronous rotating machines that can be considered to be a motor without a load or a generator without a turbine. It is an unloaded synchronous rotating machine with a DC field and excitation system that operates synchronized to the AC power grid bus frequency. During steady state operation, the synchronous condenser does not convert electric power to mechanical power or vice versa, but rather operates in this application to improve the rotor angle stability of the synchronous generator in the power plant during voltage and/or frequency deviations on the grid as described in further detail below.

### Fault Conditions

The power plant configurations described herein improve the ability of a power plant to ride through fault conditions including low voltage ride through (LVRT) conditions and frequency ride through (FRT) conditions. Particularly, the power plant configurations improve the rotor angle stability and thus allow the power plant to remain synchronous with the grid for longer periods of time under fault conditions. In other words, the power plant has an increased critical fault clearing time. A power plant with an increased fault clearing time is less likely to become unstable or trip in response to a fault.

LVRT conditions include those where voltage dips down as far as zero at the point of interconnection for a fault period. At steady state or in the absence of LVRT fault conditions, the mechanical energy of the generator unit, in the absence of losses, is equal to the electrical energy provided to the grid. When a fault happens, electrical demand is reduced at the point of interconnection but the mechanical energy remains constant. This causes the synchronous generator to accelerate. If the acceleration continues for a long enough time, the energy imbalance will result in overspeed of the rotor and when at the moment of fault clearing, the rotor angle of the synchronous generator may deviate significantly from the phase angle of the grid such that the synchronous generator loses synchronism.

FRT conditions include those where AC power grid frequency deviates (increase or decrease) from a nominal value at the point of interconnection. The frequency deviation is measured as a ramp deviation—a rate of change of frequency (Hertz per second). At steady state or in the absence of FRT conditions, the mechanical energy of the generator unit, in the absence of losses, is equal to the electrical energy provided to the grid. When the frequency of the grid decreases, the relative phase angle between the synchronous generator and the AC power grid increases and thus the electrical demand from the synchronous generator increases but mechanical energy remains constant. This causes the synchronous generator to decelerate. When this happens, if the grid frequency ramp deviation is much faster than the synchronous generator is able to decelerate, the rotor angle of the synchronous generator may deviate significantly from the phase angle of the grid such that the synchronous generator loses synchronism.

The fault period is a period of time between a time when a fault occurs and a time when the fault is removed. The ability of a unit to ride through LVRT conditions is measured by critical clearing time (CCT). Machine CCT is the maximum fault period at which a unit remains stable (synchronous) with the grid after the fault is removed. In other words, if the machine CCT exceeds the actual fault period, the unit will remain stable. If the machine CCT is less than the actual fault period, the unit becomes unstable and trips or is otherwise not synchronous with the grid after the fault is removed.

The ability of a unit to ride through FRT conditions is measured by a rate of change of frequency (ROCOF). A unit will have a machine ROCOF below which the unit will remain stable (synchronous) with the grid after the frequency ramp is removed. In other words, if the FRT condition exceeds the machine ROCOF, the unit becomes unstable and trips or is otherwise not synchronous with the grid after the fault is removed.

Many non-U.S. grid codes are requiring LVRT and FRT that are beyond the capability of traditional power plant designs. A synchronous generator with improved rotor angle stability, i.e. greater machine CCT and greater machine ROCOF, will be more capable of meeting these grid code requirements. Machine CCT and machine ROCOF are greatly affected by the pre-fault operating power factor of the machine and the system strength (equivalent impedance (Xs)) at the point of interconnection (POI). Under-excited operation of the synchronous generator and a weakly connected power system is the worst-case condition that most limits the machine CCT and machine ROCOF of a synchronous generator.

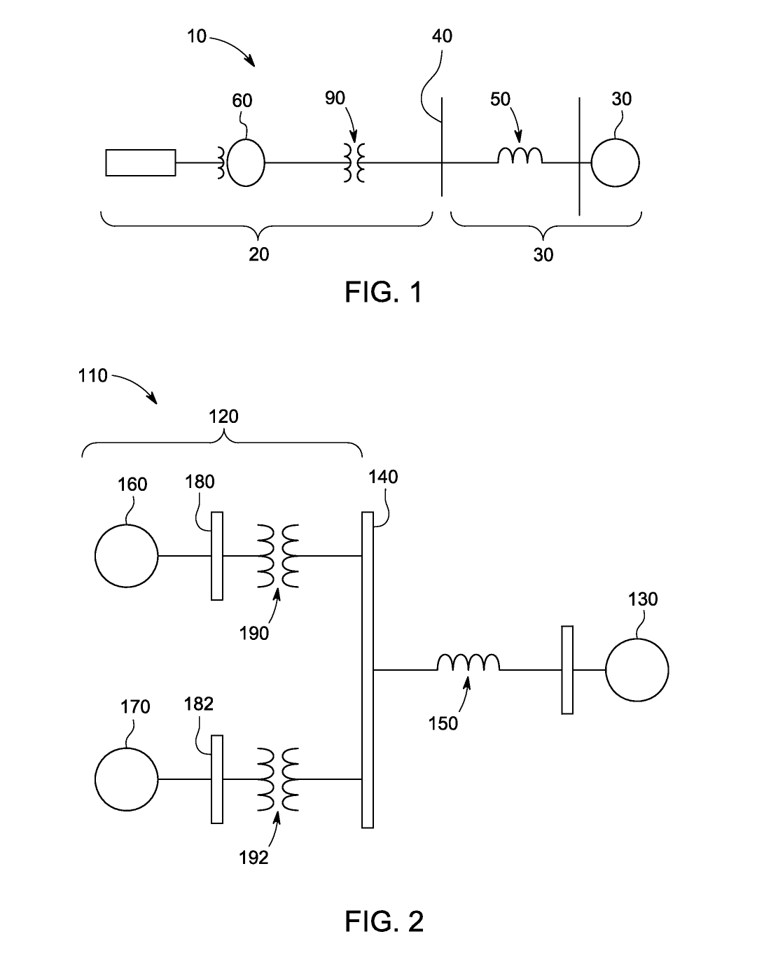

### FIG. 1

For purposes of comparison or benchmark, a power plant 10 configuration is described with reference to FIG. 1. The power plant 10 includes a unit 20 that is connected to a grid 30 at a point of interconnection 40 (e.g., a high voltage bus). The grid 30 has a system impedance 50 (Xs).

The unit 20 includes a generator 60. The generator 60 is connected to a generator step-up (GSU) transformer 90. The GSU transformer 90 is connected to the point of interconnection 40.

### Synchronous Condenser

In contrast with the power plant 10, power plants described below include a synchronous condenser that is connected in parallel to a synchronous generator. Connecting the synchronous condenser in parallel to the synchronous generator improves the machine CCT and machine ROCOF of the synchronous generator on many levels. In alternative embodiments, a synchronous condenser is connected in parallel to multiple synchronous generators.

One reason for the improved machine CCT is that the parallel connection of the synchronous condenser and the synchronous generator allows the power plant to operate at a pre-defined or initial power factor which is more inherently stable in the event of a subsequent fault. With a pre-defined over-excited power factor on the generating unit, the synchronous condenser can be operated at an MVAr setting which, together with the power plant is the correct total MVArs provided to the grid.

The synchronous generator shares or allocates reactive power to improve the stability of the operation of the synchronous generator. A rating of the synchronous condenser is selected to determine how much reactive power is shared or allocated. Increasing the steady-state stability of the synchronous generator causes the synchronous generator to remain stable for a fault with a longer fault period or higher rate of frequency change.

Another reason for the improved fault clearing time is that the connection between the synchronous generator and the synchronous condenser allows transient power to be exchanged between the synchronous generator and the synchronous condenser during a LVRT condition. This transient power (megawatts) exchange causes an acceleration-reducing effect as the synchronous condenser absorbs some of the energy from the synchronous generator. This acceleration-reducing effect may be characterized as a braking, load, exchange mechanism, damping mechanism, energy dump, or temporary storage. Because the synchronous generator accelerates less, it is more stable. Energy that is exchanged between the synchronous generator and the synchronous condenser ceases after the fault is cleared.

In addition, the synchronous condenser improves the ability of a synchronous generator to remain stable in response to a frequency ramp. A frequency ramp at the grid can cause instability due to separation of rotor angle between power plant and the grid. The addition of the synchronous condenser makes the power plant more stable for frequency excursions by supporting the local bus voltages which allow the synchronous generator to transfer more electrical energy into the grid.

This improved electrical energy transfer provides an enhanced decelerating or braking effect on the synchronous generator. By enhancing the deceleration of the generator it can withstand increased ROCOF events, thereby increasing the machine ROCOF capability. Additionally, the synchronous condenser provides transient electrical power into the grid, from its inertial response, during the ROCOF event which reduces the required electrical pickup of local synchronous generators. This grid wide benefit will result in less deceleration of the local grid frequency and therefore provides improved system stability.

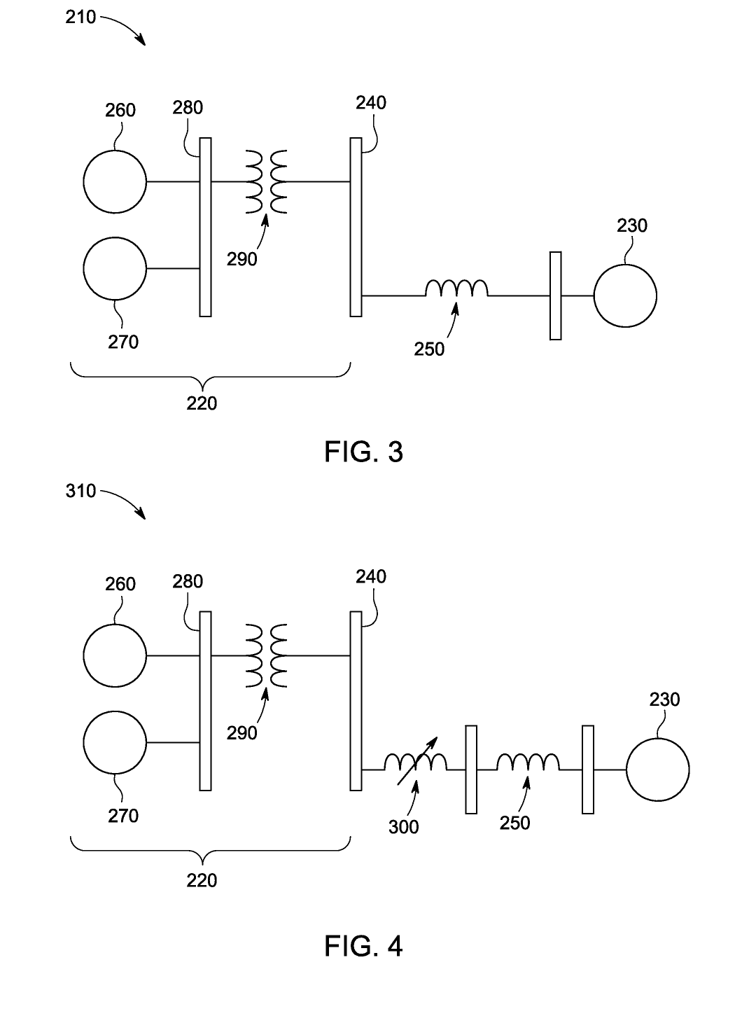

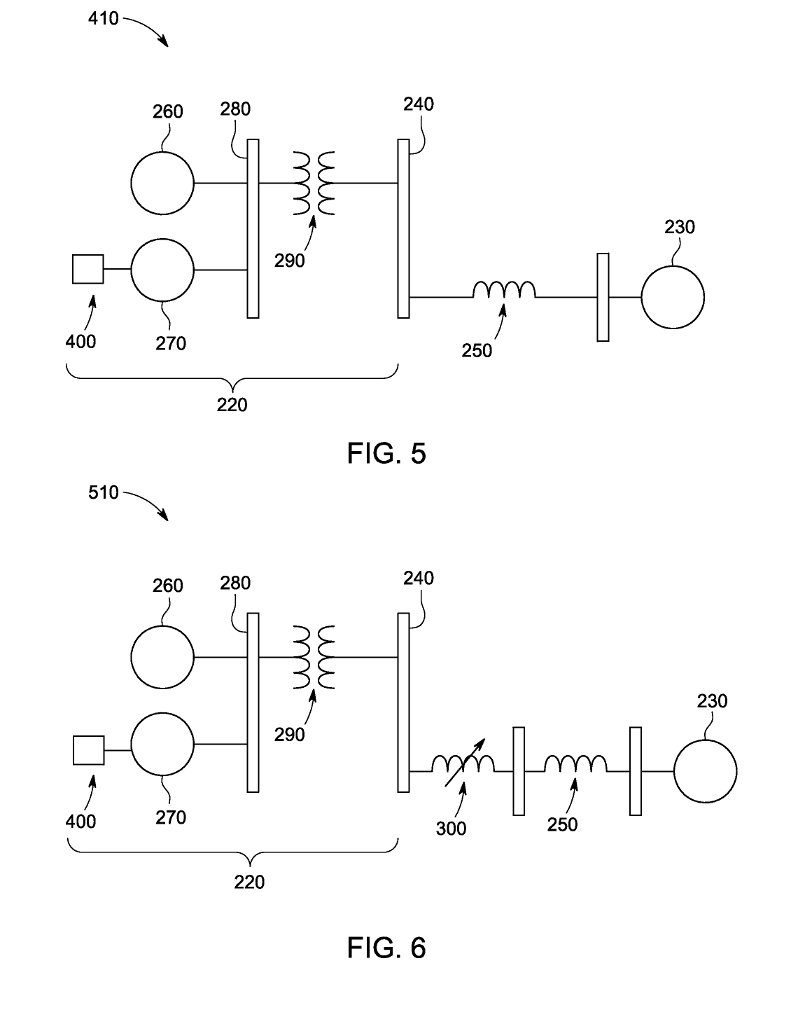

Different configurations of power plants have different effects on machine CCT and machine ROCOF. Exemplary configurations of power plants are now described in further detail. A power plant that includes a parallel-connected synchronous condenser with a dedicated step-up transformer is described with reference to FIG. 2; a power plant that includes a common bus-connected synchronous condenser that shares a common GSU transformer is described with reference to FIGS. 3-6; a power plant with a fault dip limiter is described with reference to FIG. 4; a power plant with a high inertia (H) condenser is described with reference to FIG. 5; and a power plant with a fault dip limiter and a high inertia condenser is described with reference to FIG. 6.

### FIG. 2

Referring to FIG. 2, a power plant 110 includes a unit 120 that is connected to a grid 130 at a point of interconnection 140 (e.g., a high voltage bus). The grid 130 has a system impedance 150 (Xs).

The unit 120 includes a synchronous generator 160 and a synchronous condenser 170 that are connected in parallel and have dedicated generator step up (GSU) transformers. The synchronous generator 160 is connected to a low voltage terminal bus 180, the low voltage terminal bus 180 is connected to a GSU transformer 190, and the GSU transformer 190 is connected to the point of interconnection 140. The synchronous condenser 170 is connected to a low voltage terminal bus 182, the low voltage terminal bus 182 is connected to a GSU transformer 192, and the GSU transformer 192 is connected to the point of interconnection 140.

The synchronous generator 160 and the synchronous condenser 170 of FIG. 2 are connected on the high voltage side of the transformers 190, 192 (e.g., the synchronous generator 160 and the synchronous condenser 170 are separated by the transformers 190, 192, which have impedance).

The connection between the synchronous generator 160 and the synchronous condenser 170 at the point of interconnection 140 allows the synchronous condenser 170 to absorb reactive power (MVARs) of the synchronous generator 160 as required and therefore helps the unit 120 to operate at unity or lagging power factor (overexcited) operation, an inherently more stable operation. For example, the rating of the synchronous condenser 170 may be chosen or controlled to have the capability to absorb the full reactive MVAr output of the synchronous generator 160.

### FIG. 3

Referring to FIG. 3, a power plant 210 includes a unit 220 that is connected to a grid 230 at a point of interconnection 240 (e.g., a high voltage bus). The grid 230 has a system impedance 250 (Xs).

The unit 220 includes a synchronous generator 260 and a synchronous condenser 270 that are connected in parallel and have a shared transformer. The synchronous generator 260 and the synchronous condenser 270 are each connected to a low voltage terminal bus 280, the low voltage terminal bus 280 is connected to a GSU transformer 290, and the GSU transformer 290 is connected to the point of interconnection 240.

In this configuration, a transformer does not electrically separate the synchronous generator 260 and the synchronous condenser 270. The synchronous generator 260 and the synchronous condenser 270 are connected on the low voltage side of the transformer 290. The synchronous generator 260 and the synchronous condenser 270 are closely electrically coupled (e.g., directly).

The synchronous condenser 270 on the low voltage side of the GSU transformer 290 absorbs the reactive VARs of the synchronous generator 260 and therefore helps the synchronous generator 260 to operate at unity or lagging power factor operation. To absorb the reactive VARs, the MVAr setting of the synchronous condenser 270 is determined. For example, the rating of the synchronous condenser 270 may be chosen to have the capability to absorb the full reactive MVAr output from the synchronous generator 260.

The more direct connection also allows the synchronous generator 260 and the synchronous condenser 270 to exchange transient power thereby acting as an electrical brake. The synchronous condenser 270 absorbs transient power of the synchronous generator 260 during the fault, thereby helping to reduce the rotor angle swing of the power plant 210 due to the accelerating torque applied to the turbine shaft.

### FIG. 4

A configuration of a power plant 310 that is shown in FIG. 4 is similar to the configuration of the power plant 210 that is shown in FIG. 3 except that the power plant 310 includes a fault dip limiter 300. For clarity, like numerals have been used where the elements of the power plant 310 are the same as the elements of the power plant 210.

Referring to FIG. 4 the fault dip limiter 300 is positioned between the point of interconnection 240 and system impedance 250 (Xs). The fault dip limiter 300 limits the voltage drop by reducing the short circuit current into the fault by isolating the unit 220 from the fault, thus allowing more active power transfer between the synchronous generator 260 and the synchronous condenser 270, which additionally reduces the acceleration of the synchronous generator 260.

More specifically, if voltage goes to zero at the grid 230, there is no active power transfer across the fault dip limiter 300. The fault dip limiter 300 inserts impedance/reactance during the fault period, which limits the short circuit current feed into the fault and thus improves the terminal voltage of unit 220, resulting in less power imbalance and less acceleration by the synchronous generator 260 due to improved power transfer between the synchronous generator 260 and the synchronous condenser 270. Thus the power plant 310 is in a more stable position when the fault clears.

The fault dip limiter 300 may alternatively be positioned on the transmission side or machine side (i.e., primary side or secondary side) of the transformer 290.

### FIG. 5

A configuration of a power plant 410 that is shown in FIG. 5 is similar to the configuration of the power plant 210 that is shown in FIG. 3 except that the power plant 410 includes a high inertia (H) condenser (represented by synchronous condenser 270 with a high inertia constant 400). For clarity, like numerals have been used where the elements of the power plant 410 are the same as the elements of the power plant 210.

For example, the high inertia constant 400 may be auxiliary rotational shaft mass on the synchronous condenser 270 such as a flywheel connected to the shaft of the synchronous condenser 270. The higher inertia constant 400 on the synchronous condenser 270 enables additional electrical braking transient active power to be transferred from the synchronous generator 260 to the synchronous condenser 270 during a fault condition. The higher inertia constant 400 on the synchronous condenser 270 delays the acceleration of the synchronous condenser 270 and creates more angular separation between the synchronous generator 260 and the synchronous condenser 270. This increased angular separation results in more active transient power transfer from the synchronous generator 260 to the synchronous condenser 270 and therefore reduces the acceleration of the synchronous generator 260, thus improving the stability of the power plant 410.

In alternative embodiments, a power plant is similar to the configuration of the power plant 210 that is shown in FIG. 3 except that the synchronous condenser 270 is replaced with a combination of devices including an dynamic active power device that is configured to provide a dynamic active power response and a dynamic reactive power device that is configured to provide a dynamic reactive power response. For example, the dynamic active power device is a flywheel and the dynamic reactive power device is a STATCOM. The dynamic active power device and the dynamic reactive power device are controlled by a controller such that the combined response of the dynamic active power device and the dynamic reactive power device replicates the output of the synchronous condenser 270.

### FIG. 6

A configuration of a power plant 510 that is shown in FIG. 6 is similar to the configuration of the power plant 210 that is shown in FIG. 3 except that the power plant 510 includes the fault dip limiter 300 and the high inertia condenser (represented by the synchronous condenser 270 with the high inertia constant 400). For clarity, like numerals have been used where the elements of the power plant 510 are the same as the elements of the power plants 210, 310, 410.

By combining the fault dip limiter 300 and the high inertia condenser in the power plant 510, the benefits of power plants 310, 410 described above are compounded.

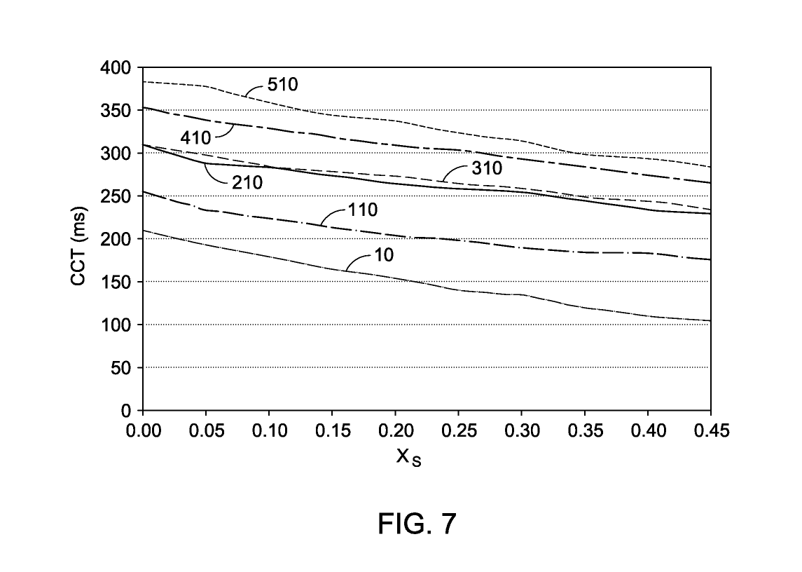

### FIG. 7

FIG. 7 is a graphical illustration of machine CCT vs. Impedance (Xs) for the power plants 10, 110, 210, 310, 410, 510. Generally, machine CCT depends on impedance (Xs) between the unit of the power plant and the grid. If impedance (Xs) increases, machine CCT will decrease. As shown, the machine CCT (y-axis) decreases as the grid impedance (x-axis) increases (i.e. as the system strength weakens).

FIG. 7 illustrates the machine CCT for each of the power plants 10, 110, 210, 310, 410, 510 for various grid impedance (Xs). The synchronous generator used in the analysis for each of the power plants 10, 110, 210, 310, 410, 510 is a 535.5 MVA single shaft combined cycle power plant. However, the disclosure will provide benefits to any synchronous generating unit irrespective of the mechanical train configuration (e.g., steam, gas, or combined cycle).

The graphed machine CCTs correspond to the marginally stable point of operation for the power plants 10, 110, 210, 310, 410, 510; thus indicating the extreme worst operating condition, a lagging power factor. If the power plant meets a CCT requirement under this operating condition, it will meet the requirement under all operating conditions.

As can be seen in FIG. 7, each of the configurations of the power plants 110, 210, 310, 410, 510 increase the machine CCT relative to the configuration of the power plant 10. The maximum machine CCT for the power plant 10 is 210 ms when the grid impedance (Xs) is zero (infinite grid strength). This is an ideal condition. The value of grid impedance ranges between 0% and 45%. Referencing FIG. 7, the power plant 10 will only pass a CCT requirement of 150 ms under grid impedances of less than 20%, while it does not pass a CCT requirement of 250 ms for any grid strength.

However, the machine CCT of the power plants 110, 210, 310, 410, 510 increase the CCT over the range of system impedances to better meet or comply with the current grid code requirements. Power plant 110 has a machine CCT that is approximately 50 ms greater than that of power plant 10; power plant 210 has a machine CCT that is approximately 100 ms greater than that of power plant 10; and power plants 310, 410, 510 have a machine CCT that is approximately 100 to 150 ms greater than that of power plant 10.

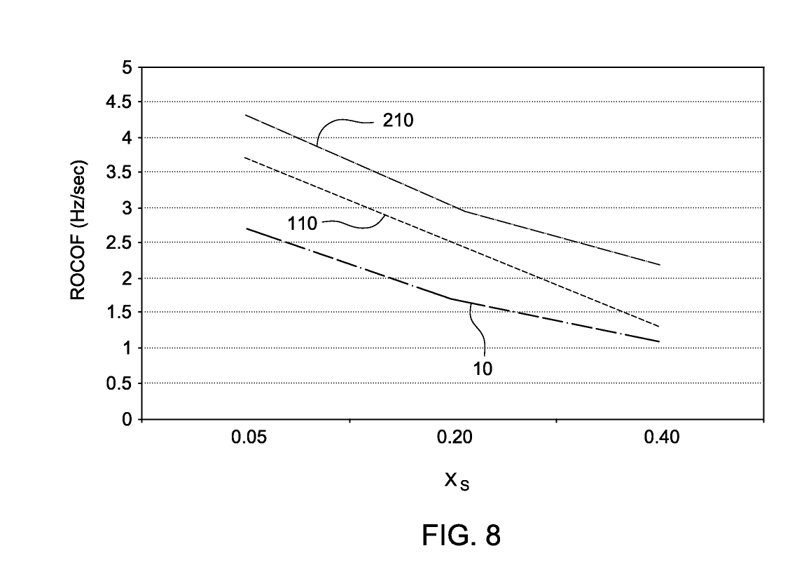

### FIG. 8

FIG. 8 is a graphical illustration of machine ROCOF vs. Impedance (Xs) for the power plants 10, 110, 210. Power plants 310, 410, 510 may have similar or improved machine ROCOF relative to that of power plant 210. Generally, machine ROCOF depends on impedance (Xs) between the unit of the power plant and the grid. If impedance (Xs) increases, machine ROCOF will decrease. As shown, the machine ROCOF (y-axis) decreases as the grid impedance (x-axis) increases (i.e. as the system strength weakens).

FIG. 8 illustrates the machine ROCOF for each of the power plants 10, 110, 210 for various grid impedance (Xs). Each of the configurations of the power plants 110, 210 has a machine ROCOF that is increased relative to that of the configuration of the power plant 10. The increased machine ROCOF of power plants 110, 210 over the range of system impedances better meets or complies with the current grid code requirements. For example, at a system impedance (Xs) of 0.05, power plant 110 machine ROCOF is approximately 1 Hz/sec greater than that of power plant 10 and power plant 210 machine ROCOF is approximately 1.5 Hz/sec greater than that of power plant 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A power plant, comprising:
a synchronous generator and a synchronous condenser connected to a first low voltage terminal bus; and
a step-up transformer connected between the low voltage bus and a high voltage bus, wherein the high voltage bus is a point of interconnection from the power plant to a power grid.

2. The power plant of claim 1, wherein the synchronous generator is an electrical rotating machine that is coupled mechanically by a rotating shaft to a prime mover to convert mechanical power into electrical power.

3. The power plant of claim 2, wherein the synchronous condenser is an unloaded rotating machine.

4. The power plant of claim 3, wherein each of the synchronous generator and the synchronous condenser includes a DC field and excitation system that operates in synchronism to the power grid.

5. The power plant of claim 1, further comprising a fault dip limiter.

6. The power plant of claim 5, wherein the fault dip limiter is configured to insert impedance during a fault period.

7. The power plant of claim 5, wherein the fault dip limiter is connected between the grid and the high voltage bus.

8. The power plant of claim 5, wherein the fault dip limiter is connected between the step-up transformer and the low voltage bus.

9. The power plant of claim 1, wherein the synchronous condenser is a high inertia condenser.

10. The power plant of claim 9, wherein the synchronous condenser includes an auxiliary rotational shaft mass.

11. The power plant of claim 9, comprising a fault dip limiter.

12. The power plant of claim 11, wherein the fault dip limiter is configured to insert impedance during a fault period.

13. The power plant of claim 11, wherein the fault dip limiter is connected between the grid and the high voltage bus.

14. The power plant of claim 11, wherein the fault dip limiter is connected between the step-up transformer and the low voltage bus.

15. A power plant, comprising:
a synchronous generator connected to a first low voltage terminal bus;
a first step up transformer connected between the first low voltage bus and a high voltage bus;
a synchronous condenser connected to a second low voltage terminal bus; and
a second step up transformer connected between the second low voltage bus and the high voltage bus;
wherein the high voltage bus is a point of interconnection from the power plant to a power grid.

16. The power plant of claim 15, wherein the synchronous generator is an electrical rotating machine that is coupled mechanically by a rotating shaft to a prime mover to convert mechanical power into electrical power.

17. The power plant of claim 16, wherein the synchronous condenser is an unloaded rotating machine.

18. The power plant of claim 15, comprising a fault dip limiter connected between the grid and the high voltage bus.

19. The power plant of claim 15, wherein the synchronous condenser is a high inertia condenser.

20. A power plant, comprising:
a synchronous generator;
a dynamic active power device that is configured to provide a dynamic active power response; and
a dynamic reactive power device that is configured to provide a dynamic reactive power response;
wherein the synchronous generator, the dynamic active power device, and the dynamic reactive power device are connected to a first low voltage terminal bus; and
a step-up transformer connected between the low voltage bus and a high voltage bus, wherein the high voltage bus is a point of interconnection from the power plant to a power grid.
